(19) United States
(12) Patent Application Publication
(10) Pub. No.: US 2011/0042906 A1
(43) Pub. Date: Feb. 24, 2011

(54) CHUCK FOR WAFERS

(76) Inventor: Johann AICHHOLZER, Klagenfurt (AT)

Correspondence Address: YOUNG & THOMPSON, 209 Madison Street, Suite 500, Alexandria, VA, 22314, US

(21) Appl. No.: 12/860,107

(22) Filed: Aug. 20, 2010

(30) Foreign Application Priority Data
Aug. 20, 2009 (AT) GM 5232009

(51) Int. Cl. B23B 31/06

(52) U.S. Cl. 279/155

(57) ABSTRACT

In a chuck (1) for a wafer (8), on the top of the disk (2) of the chuck (1), a ceramic plate (6) is placed that with an annular elevation (7) that projects upward defines the region in which the wafer (8) will be placed. To place and lift the wafer (8) off the plate (6), there are lifting pins (12) that can be moved in the sleeves (11) of the chuck (1). To prevent the plate (6) on the top (5) of the chuck (1) from being raised and to prevent process media from being able to penetrate between the disk (2) of the chuck (1) and the plate (6), the sleeves (6) in which the lifting pins (12) are guided are connected to the plate (6), so that the latter is always held in tight contact with the disk (2) of the chuck (1).

The invention relates to a chuck for a disk-shaped article, especially a wafer (silicon wafer), with a support surface that is formed by a plate, especially a ceramic plate, for the article, and with lifting pins that can be extended out of the support surface for lifting the article and that are guided in sleeves that have been inserted into the chuck.

Such chucks for wafers are known.

In certain steps for processing wafers with the objective of producing semiconductors from them, it is necessary to process and, if necessary, heat the wafers with gaseous or liquid media. To do this, heating the wafer that has been placed on a chuck that consists especially of ceramic or metal is known. Heating can take place such that the heat is transferred to the wafer by way of a ceramic plate that has been placed on the actual chuck.

In known embodiments, the plate that has been placed on the chuck has four openings from which lifting pins made of ceramic can be advanced in order to lift the wafer off the plate so that the wafer, after it has been treated, can be removed using grippers or spoons and moved away.

When wafers are placed on the chuck, in order to enable the gripper or spoon to move away, the wafer is first placed on the extended lifting pins and only after the gripper or the spoon has been moved away can the wafer be deposited on the plate that has been placed on the chuck by retracting the lifting pins.

The lifting pins are guided in ceramic sleeves that are attached in the chuck, especially pressed into it.

The end of the lifting pins that lies in the holes in the plate of the chuck is made to widen in the manner of a truncated cone and fits exactly into the accordingly conical top end of the opening in the plate.

In order to achieve good heat transfer from the chuck to the plate, the plate should rest flat on the chuck without gaps. Contaminants between the plate and the top of the chuck prevent heat transfer. The top side of the chuck can be damaged by a distance between the plate and chuck so that good heat transfer from the chuck to the plate is prevented. It can happen that the plate is moved at the same time when the lifting pins are extended so that the aforementioned contaminants can penetrate into the space between the plate and the top of the chuck.

The object of the invention is to make available a chuck of the initially mentioned type that does not have the aforementioned disadvantages.

This object is achieved according to the invention with a chuck that has the features of Claim 1.

Preferred and advantageous embodiments of the chuck according to the invention are the subject matter of the subclaims.

Since in the chuck according to the invention the plate is connected to the sleeves provided in the chuck (and connected in a fixed manner to the latter), there is the danger that the plate does not lie properly or is not raised off the top of the chuck when the lifting pins are extended. Thus, the danger of contaminants is also eliminated. Also, the danger that liquid/gaseous media that are covering the wafer will penetrate between the plate that consists especially of ceramic and the top of the chuck is eliminated since the plate is held by the pins fixed in the chuck and remains in tight contact with the top of the chuck.

The measure according to the invention ensures that the plate will rest satisfactorily on the chuck at the top of the chuck by the sleeves that are attached in the chuck and that are connected to the plate (integrated sleeves), and the space between the top of the chuck and the bottom of the plate will be closed.

The measures according to the invention also prevent contaminants and/or process media in the vicinity of the openings for the lifting pins from penetrating through the gap between the chuck, plate and sleeve, attacking the material (for example, metal) of the chuck and damaging the latter on the surface.

In one embodiment of the invention, it can be provided that the sleeves are made in one piece with the plate.

In one embodiment of the invention, it can be provided that the sleeves are screwed to the plate.

In one embodiment of the invention, it can be provided that on the side of the plate facing the chuck, there are projections via which the sleeves are connected, especially screwed, to the plate.

In one embodiment of the invention, it can be provided that the plate has a ring on its outside edge.

In one embodiment of the invention, it can be provided that the ring overlaps the lateral outer surface of the chuck, especially its disk.

In one embodiment of the invention, it can be provided that there is play between the outer surface of the chuck, especially its disk, and the inner surface of the ring.

In one embodiment of the invention, it can be provided that the chuck is assigned a means for heating the chuck.

In one embodiment of the invention, it can be provided that the means for heating the chuck is integrated into the chuck.

In one embodiment of the invention, it can be provided that the sleeves consist of ceramic.

In one embodiment of the invention, it can be provided that the lifting pins can be extended by a common drive, especially a lifting ring.

In one embodiment of the invention, it can be provided that the lifting pins consist of ceramic.

In one embodiment of the invention, it can be provided that the means for heating the chuck is a resistance heating installation integrated into the chuck.

In one embodiment of the invention, it can be provided that the chuck for an inductive heating means consists at least partially of an inductively conductive material.

In one embodiment of the invention, it can be provided that on the top of the plate, there is at least one elevation that surrounds the region in which an article can be placed on the chuck.

Other details and features of the invention will become apparent from the following description of preferred embodiments with reference to the drawings.

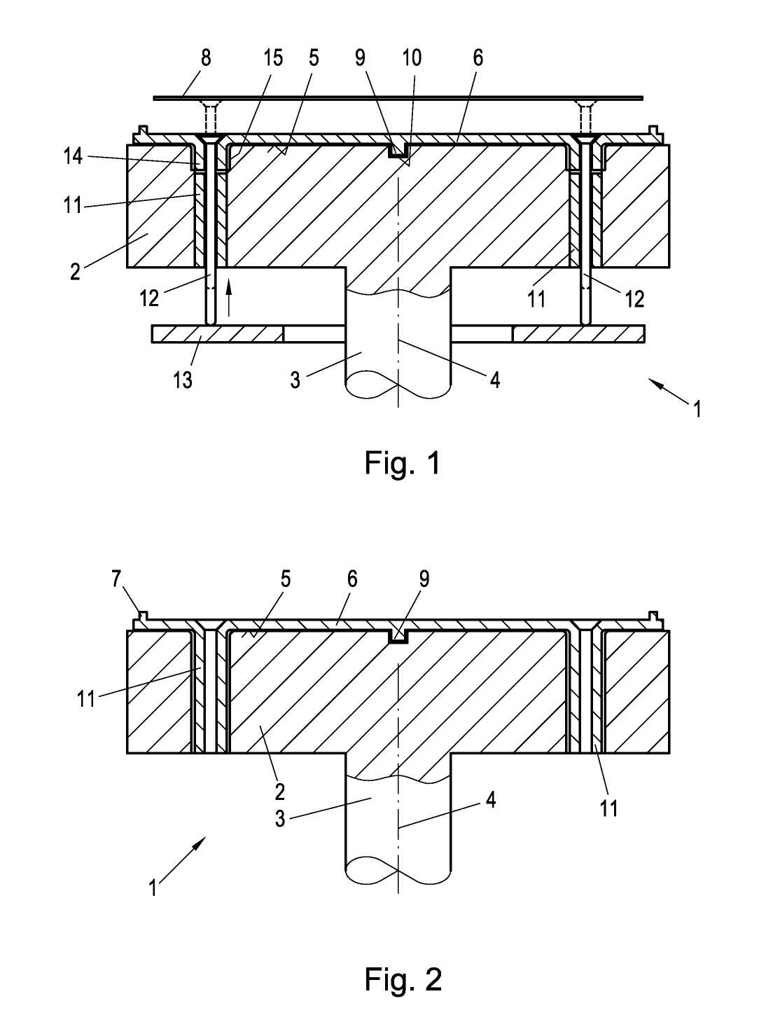

FIG. 1 schematically shows in section a chuck of the prior art;

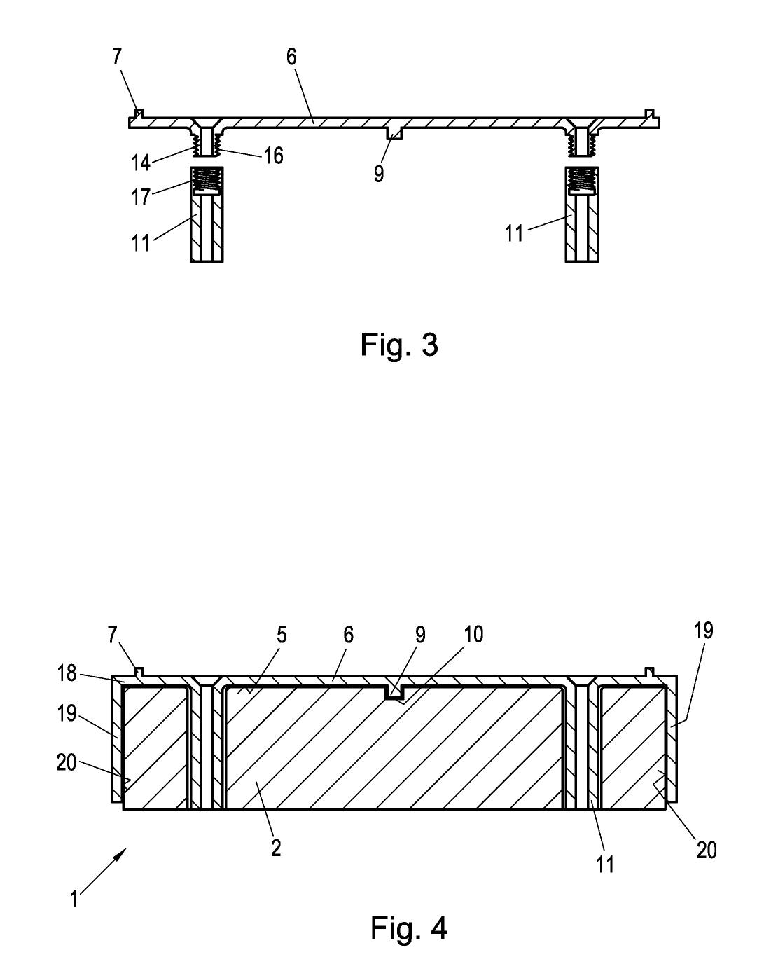

FIG. 2 shows a chuck according to the invention without lifting pins;

FIG. 3 shows a ceramic plate with sleeves (broken down);

FIG. 4 shows a modified embodiment of a chuck;

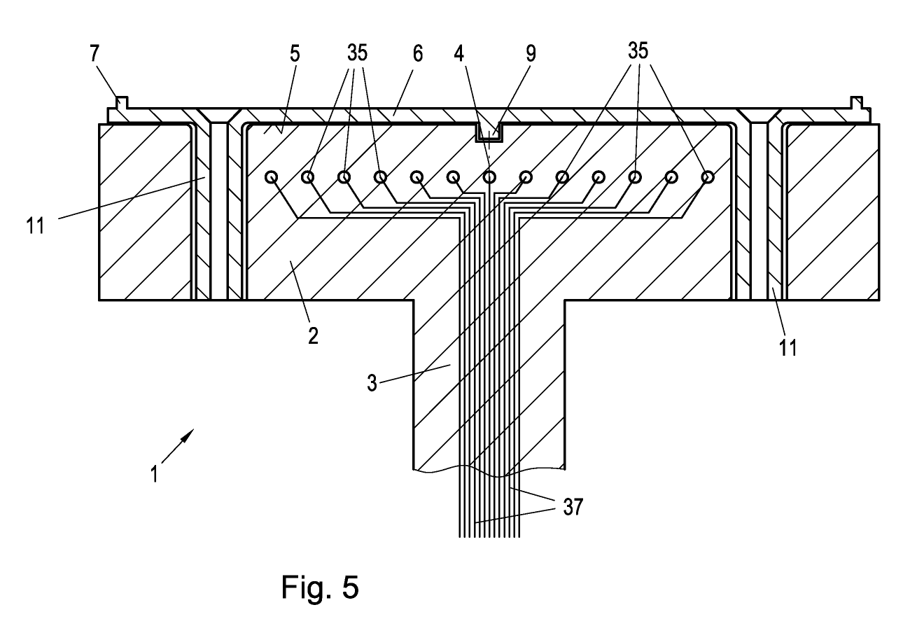

FIG. 5 shows an embodiment with heating in the chuck; and

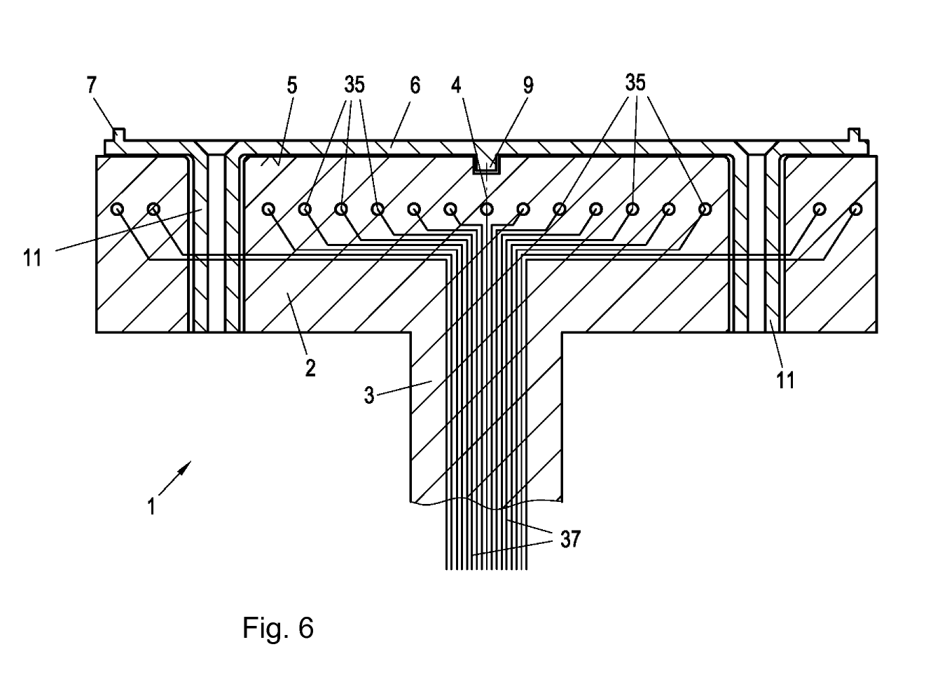

FIG. 6 shows another embodiment with heating in the chuck.

A known chuck 1 shown in FIG. 1 consists of a generally round disk 2 made of metal that is held by way of a shaft 3 and optionally can be set into rotation around its axis 4.

On the top 5 of the disk 2 of the chuck 1, there rests a plate 6 that generally consists of ceramic. On the top of the plate 6, there is one annular projection 7 (or several projections located around it) as an elevation that borders the region in which a wafer 8 can be placed on the chuck 1, more exactly its plate 6. For exact guidance of the plate 6 relative to the plate 2 of the chuck 1, in its middle, there is a projection 9 that points downward and that engages an opening 10 (recess) that is open toward the top 5 of the disk 2 of the chuck 1.

In the disk 2 of the chuck 1 in axially parallel bores, sleeves 11 that consist especially of ceramic are fixed, for example pressed in. Lifting pins 12 that likewise consist of ceramic are movably held in the sleeves 11. To actuate the lifting pins 12 in order to extend them out of the readiness position shown in FIG. 1 in solid lines into the action position that is shown in FIG. 1 by broken lines, underneath the disk 2 of the chuck 1 there is a lifting ring 13 that acts from underneath on all (generally four) lifting pins 12 in order to extend or lower the latter.

The upper ends of the lifting pins 12 that are raised in their action position relative to the plate 6 are made conically widening and are held in the readiness position in the correspondingly countersunk openings of the plate 6. The plate 6, as known in the prior art, rests loosely on the disk 2 and engages in recesses 15 of the disk 2 of the chuck 1 with the projections 14 that point downward.

In the embodiment of a chuck 1 according to the invention shown in FIG. 2, the plate 6 is made in one piece with the sleeves 7 that are fixed in the disk 2 of the chuck 1. Thus, it is ensured that the plate 6 cannot be raised off the top 5 of the disk 2 of the chuck 1 when the lifting pins 12 are being extended (not shown in FIG. 2).

FIG. 3 shows one alternative embodiment of the connection between plate 6 and sleeves 11. In this embodiment, there are external threads 16 on the projections 14 of the chuck plate 6 that point downward. In the upper ends of the sleeves 11 that face the plate 6, there are sections with an internal thread 17. Thus, the sleeves 11 can be screwed to the plate 6 via their projections 14 in order to connect them to the plate 6 in a fixed manner.

FIG. 4 shows one modification of the embodiment shown in FIG. 2, the chuck 1 being made without a shaft 3 on the disk 2. In the embodiment from FIG. 4, the ceramic plate 6 is also made in one piece either with the sleeves 11 or the sleeves 11 are screwed to the plate 6 as in the embodiment from FIG. 3. In the embodiment shown in FIG. 4, the plate 6 is additionally secured by its being provided on its peripheral edge 18 with a ring 19 that is made especially in one piece with the plate 6 and that adjoins the outer side surface 20 of the disk 2 of the chuck 1, covering it. Thus, the chuck 1 is also protected laterally and the penetration of process medium between plate 6 and disk 2 of the chuck 1 is additionally prevented. The ring 19 can be made of ceramic material in one piece with the plate 6. In one preferred embodiment, there is play between the outer side surface 20 of the disk 2 of the chuck 1 and the inner surface of the ring 19 in order to take into account different coefficients of thermal expansion of the material of the disk 2 and of the ring 19.

The disk 2 of the chuck 1 can be provided with a means for heating the chuck, if the heating of the plate 6 or of a wafer 8 does not take place by other means, such as radiators or heat lamps.

If, in the chuck 1, there is a means for heating the latter and thus the plate 6 as well as the wafer 8, this heating means can be resistance heating installation integrated into the chuck 1 or there is an inductive means, the chuck 1, especially its disk 2, consisting at least partially of inductively conductive material. One example of a heating installation integrated into a disk 2 is shown in FIG. 5. In the embodiment of the chuck 1 that is shown in FIG. 5 and that is located over a shaft 3 in a vacuum chamber, there is an electrical resistance heating installation 35 in the disk 2 of the chuck 1. In the embodiment shown in FIG. 5, the chuck 1 consists of metal, and electrical lines 37 that supply electricity to the electrical resistance heating installation 35 in the chuck 1 in order to heat the chuck 1 are routed via its shaft 3. Since in the embodiment shown in the figures the chuck 1 for the wafer is equipped with a heating means, it is no longer necessary to heat the chuck 1 by supplying radiant heat that originates from an external source.

In the embodiment shown in FIG. 5, the resistance heating installation 35 is located within the sleeves 11 for the lifting pins 12; conversely, in the embodiment shown in FIG. 6, there is also a resistance heating installation 35 outside of the sleeves 11 for the lifting pins 12.

This has the advantage that the costs of material, energy and maintenance are reduced.

There can also be a heating installation as has been described above and in conjunction with FIGS. 5 and 6 and in the other embodiments shown in FIGS. 2 to 4.

In summary, one embodiment of the invention can be described as follows:

In a chuck 1 for a wafer 8, on the top of the disk 2 of the chuck 1, a plate 6 is placed that with an annular elevation 7 that projects upward defines the region in which a wafer 8 will be placed. To place and lift the wafer 8 off the plate 6, there are lifting pins 12 that can be moved in the sleeves 11 of the chuck 1. To prevent the plate 6 on the top 5 of the chuck 1 from being raised and to prevent process media from being able to penetrate between the disk 2 of the chuck 1 and the plate 6, the sleeves 6 in which the lifting pins 12 are guided are connected to the plate 6 so that the latter is always held in tight contact with the disk 2 of the chuck 1.

1. Chuck (1) for a disk-shaped article (8), especially a wafer (silicon wafer), with a support surface that is formed by a plate (6), especially a ceramic plate (6), for the article (8), and with lifting pins (12) that can be extended out of the support surface for lifting the article (8), and that are guided in sleeves (11) that have been inserted into the chuck (1), characterized in that the plate (6) is connected to the sleeves (11).

2. Chuck according to claim 1, wherein the sleeves (11) are made in one piece with the plate (6).

3. Chuck according to claim 1, wherein the sleeves (11) are screwed to the plate (6).

4. Chuck according to claim 1, wherein on the side of the plate (6) facing the chuck (1), there are projections (14) via which the sleeves (11) are connected, especially screwed, to the plate (6).

5. Chuck according to claim 1, wherein the plate (6) has a ring (19) on its outside edge (18).

6. Chuck according to claim 5, wherein the ring (19) overlaps the lateral outer surface (20) of the chuck (1), especially of its disk (2).

7. Chuck according to claim 6, wherein there is play between the peripheral surface (20) of the chuck (1), especially its disk (2), and the inner surface of the ring (19).

8. Chuck according to claim 1, wherein the chuck (1) is assigned a means for heating the chuck (1).

9. Chuck according to claim 8, wherein the means for heating the chuck (1) is integrated into the chuck.

10. Chuck according to claim 1, wherein the sleeves (11) consist of ceramic.

11. Chuck according to claim 1, wherein the lifting pins (12) can be extended by a common drive (13), especially a lifting ring (13).

12. Chuck according to claim 1, wherein the lifting pins (12) consist of ceramic.

13. Chuck according to claim 1, wherein the means for heating the chuck (1) is a resistance heating installation integrated into the chuck (1).

14. Chuck according to claim 1, wherein the chuck (1) for an inductive heating means consists at least partially of inductively conductive material.

15. Chuck according to claim 1, wherein on the top of the plate (6), there is at least one elevation (7) that surrounds the region in which an article (8) can be placed on the chuck (1).

16. Chuck according to claim 3, wherein on the side of the plate (6) facing the chuck (1), there are projections (14) via which the sleeves (11) are connected, especially screwed, to the plate (6).
